(19) United States
(12) Patent Application Publication
(10) Pub. No.: US 2025/0123671 A1
(43) Pub. Date: Apr. 17, 2025

(54) DISPLAY DEVICE

(71) Applicant: LG ELECTRONICS INC., Seoul (KR)

(72) Inventors: Hanjin CHO, Seoul (KR); Gunhee GWAG, Seoul (KR)

(73) Assignee: LG ELECTRONICS INC., Seoul (KR)

(21) Appl. No.: 18/685,472

(22) PCT Filed: Sep. 8, 2021
(86) PCT No.: PCT/KR2021/012203

§ 371 Date: Feb. 21, 2024

(51) Int. Cl. G06F 1/3218; H04N 5/57; H04N 5/60; H04N 5/63

(52) U.S. Cl. CPC G06F 1/3218; H04N 5/57; H04N 5/602; H04N 5/63

(57) ABSTRACT

The present disclosure provides a display device including a display unit configured to output an image source, a motor configured to provide a power source for movement of the display unit, a panel power supply unit configured to output power supplied from an external power source to the display unit or the motor, and a processor configured to receive a movement command for the display unit, determine whether motor driving power required for the motor is secured in response to the movement command, and when it is determined that the motor driving power is secured, control the motor receiving power from the panel power supply unit to perform a moving operation of the display unit.

### TECHNICAL FIELD

The present disclosure relates to a display device, and more particularly, to a display device capable of reducing a power design capacity for a motor provided therein, and a motor control method.

### BACKGROUND ART

A display device is a device that displays image information received from the outside or image information stored therein. Examples of a representative display device include a television, a monitor, a laptop, and a smartphone.

However, a conventional mobile display device, such as a smartphone, is limited in size for portability. In contrast, a relatively large display device, such as a TV, requires a large installation space and is inconvenient to move.

To solve this problem, a recent display device uses a foldable display or a rollable display.

In addition, recently, a portrait mode image as well as a landscape mode image has been gaining popularity. In general, a relatively large display device, such as a TV, has a display screen size optimized for a landscape mode image.

To solve this problem, recent display devices support a function of rotating a display from a landscape mode to a portrait mode.

However, a display device may require a motor for folding or rolling a display, and a power supply module capable of supplying power to the motor has to be designed separately. Accordingly, a cost increase problem such as the need to additionally design a power circuit for supplying power to a motor may occur.

### DISCLOSURE OF INVENTION

### Technical Problem

An object of the present disclosure is to provide a display device capable of reducing costs by allowing a motor to receive power from another power supply module without designing a separate motor-only power supply module.

An object of the present disclosure is to provide a display device capable of supplying power to a motor from another power supply module by reducing power used in other power-consuming modules by an amount required to drive a motor.

### Technical Solution

A display device according to an embodiment of the present disclosure includes a display unit configured to output an image source, a motor configured to provide a power source for movement of the display unit, a panel power supply unit configured to output power supplied from an external power source to the display unit or the motor, and a processor configured to receive a movement command for the display unit, determine whether motor driving power required for the motor is secured in response to the movement command, and when it is determined that the motor driving power is secured, control the motor receiving power from the panel power supply unit to perform a moving operation of the display unit.

When it is determined that the motor driving power is not secured, the display device according to an embodiment of the present disclosure includes the processor configured to change image output setting information of the image source to secure the motor driving power required for the motor.

The display device according to an embodiment of the present disclosure includes the processors configured to change the image output setting information by setting an image brightness setting of the image source to be darker than an existing image brightness setting and secure the motor driving power required for the motor.

The display device according to an embodiment of the present disclosure includes the processor configured to change the image output setting information by setting an image size setting of the image source to be smaller than an existing image size setting and secure the motor driving power required for the motor.

The display device according to an embodiment of the present disclosure includes the processor configured to perform a moving operation of the display unit and change the image output setting information of the image source to existing image output setting information.

The display device according to an embodiment of the present disclosure includes a sound power supply unit configured to output the power supplied from the external power source to the audio output unit or the motor, wherein, when it is determined that the motor driving power is secured, the processor is configured to control the motor receiving the power from the sound power supply unit to perform the moving operation of the display unit.

The display device of claim 6 according to an embodiment includes a process configured to, when it is determined that the motor driving power is not secured, change sound output setting information of the image source to secure the motor driving power required for the motor.

The display device according to an embodiment of the present disclosure includes the processor configured to perform the moving operation of the display unit and change the sound output setting information of the image source to existing sound output setting information.

The display device according to an embodiment of the present disclosure includes the processor configured to obtain an expected motor driving time for securing the motor driving power required for the motor, and perform the moving operation of the display unit by controlling the motor receiving the power from the panel power supply unit for the obtained expected motor driving time.

The display device according to an embodiment of the present disclosure includes the processor configured to obtain image display power consumption of the display unit in a first image reproduction section based on the image source, determine whether the motor driving power is secured, based on the obtained image display power consumption and limit power consumption, and when it is possible to secure the motor driving power in the first image reproduction section, obtain an expected motor driving time from a reproduction start time to a reproduction end time of the first image reproduction section.

The display device according to an embodiment of the present disclosure includes a processor configured to, when it is impossible to secure the motor driving power in the first image reproduction section, shift the first image reproduction section by a predetermined time and determine whether it is possible to secure the motor driving power in a second image reproduction section.

The movement command according to an embodiment of the present disclosure includes at least one of commands for rotating, folding, rolling, and moving the display unit.

The display device according to an embodiment of the present disclosure includes the processor configured to determine whether the motor driving power required for the motor from start of the moving operation of the display unit corresponding to the movement command to completion of the moving operation of the display unit is secured.

The display device according to an embodiment of the present disclosure includes the processor configured to determine whether the motor driving power required for the motor is secured, based on limit power consumption and total power consumption of the display device.

### ADVANTAGEOUS EFFECTS

According to an embodiment of the present disclosure, it is possible to provide a display device capable of reducing a cost of a power supply module by allowing a motor to receive power from another power supply module without designing a separate motor-only power supply module.

According to an embodiment of the present disclosure, it is possible to provide a display device capable of supplying power to a motor from another power supply module by reducing power used in other power-consuming modules by an amount required to drive a motor.

### BRIEF DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure,

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5 is a block diagram illustrating a power supply unit according to an embodiment of the related art.

FIG. 6 is a block diagram illustrating a power supply unit according to an embodiment of the present disclosure.

FIG. 7 is a flowchart for describing a motor control method according to an embodiment of the present disclosure.

FIG. 8 is a view for describing a motor control method for securing motor driving power by changing image output setting information of an image source according to an embodiment of the present disclosure.

FIG. 9 is a view for describing a motor control method for securing motor driving power by changing image output setting information of an image source according to an embodiment of the present disclosure.

FIG. 10 is a view for describing a motor control method for securing motor driving power by changing image output setting information of an image source according to an embodiment of the present disclosure.

FIG. 11 is a diagram for describing a motor control method for securing motor driving power by waiting until an image section in which driving power can be secured according to an embodiment of the present disclosure.

### BEST MODE FOR CARRYING OUT THE INVENTION

Hereinafter, embodiments relating to the present disclosure will be described in detail with reference to the accompanying drawings. The suffixes “module” and “unit” for components used in the description below are assigned or mixed in consideration of easiness in writing the specification and do not have distinctive meanings or roles by themselves.

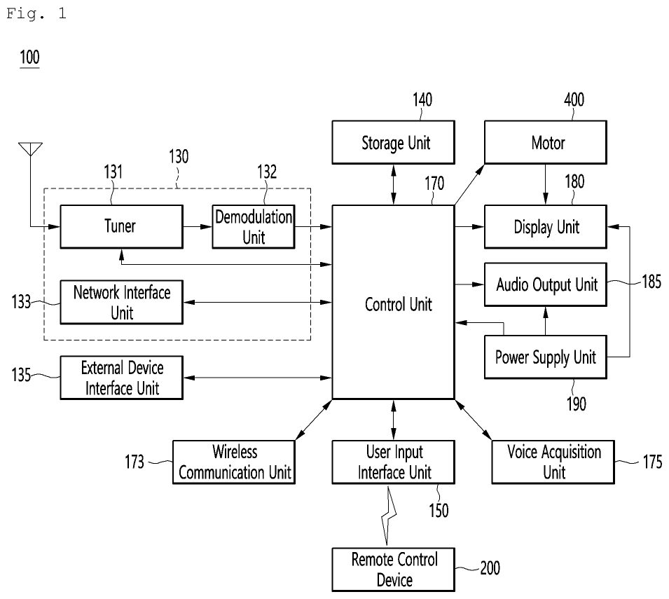

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input interface unit 150, a control unit 170, a wireless communication unit 173, a display unit 180, an audio output unit 185, and a power supply unit 190.

The broadcast reception module 130 may include a tuner 131, a demodulation unit 132, and a network interface unit 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The network interface unit 133 may provide an interface for connecting the display device 100 to a wired/wireless network comprising internet network. The network interface unit 133 may transmit or receive data to or from another user or another electronic device through an accessed network or another network linked to the accessed network.

The network interface unit 133 may access a predetermined webpage through an accessed network or another network linked to the accessed network. That is, the network interface unit 133 may transmit or receive data to or from a corresponding server by accessing a predetermined webpage through the network.

The network interface unit 133 may receive content or data provided from a content provider or a network operator. That is, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface unit 133 may select and receive a desired application among applications open to the air, through network.

The external device interface unit 135 may receive an application or an application list in an adjacent external device and deliver the application or the application list to the control unit 170 or the storage unit 140.

The external device interface unit 135 may provide a connection path between the display device 100 and an external device. The external device interface unit 135 may receive at least one of an image or audio outputted from an external device that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external device inputted through the external device interface unit 135 may be outputted through the display unit 180. A sound signal of an external device inputted through the external device interface unit 135 may be outputted through the audio output unit 185.

An external device connectable to the external device interface unit 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (e.g., video files, still image files, music files, document files, application files, etc.) stored in the storage unit 140, and may provide the content files to a user.

The user input interface unit 150 may transmit signals input by a user to the control unit 170, or may transmit signals from the control unit 170 to a user. For example, the user input interface unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input interface unit 150 may transmit, to the control unit 170, control signals input from local keys (not shown) such as a power key, a channel key, a volume key, and a setting key.

Image signals that are image-processed by the control unit 170 may be input to the display unit 180 and displayed as images corresponding to the image signals. In addition, image signals that are image-processed by the control unit 170 may be input to an external output device through the external device interface unit 135.

Voice signals processed by the control unit 170 may be output to the audio output unit 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input interface unit 150, and may access the network to download a desired application or application list into the display device 100.

The control unit 170 may output channel information selected by a user together with the processed image or voice signals through the display unit 180 or the audio output unit 185.

In addition, the control unit 170 may output image signals or voice signals of an external device such as a camera or a camcorder, which are input through the external device interface unit 135, through the display unit 180 or the audio output unit 185, according to an external device image playback command received through the user input interface unit 150.

Moreover, the control unit 170 may control the display unit 180 to display images, and may control the display unit 180 to display broadcast images input through the tuner 131, external input images input through the external device interface unit 135, images input through the network interface unit, or images stored in the storage unit 140. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication unit 173 may perform wired or wireless communication with an external device. The wireless communication unit 173 may perform short-range communication with an external device. For this, the wireless communication unit 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication unit 173 may detect (or recognize) a wearable device capable of communication around the display device 100. Furthermore, if the detected wearable device is a device authenticated to communicate with the display device 100, the control unit 170 may transmit at least part of data processed in the display device 100 to the wearable device through the wireless communication unit 173. Therefore, a user of the wearable device may use the data processed by the display device 100 through the wearable device.

The voice acquisition unit 175 may acquire audio. The voice acquisition unit 175 may include at least one microphone (not shown) and may acquire audio around the display device 100 through the microphone (not shown).

The display unit 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 shown in FIG. 1 is just one embodiment of the present disclosure and thus, some of the components shown may be integrated, added, or omitted according to the specification of the actually implemented display device 100.

That is, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display unit 180 and the audio output unit 185.

The audio output unit 185 receives the audio-processed signal from the control unit 170 to output an audio signal.

The power supply unit 190 supplies the corresponding power to the entire display device 100. Particularly, power may be supplied to the control unit 170 that is capable of being implemented in the form of a system on chip (SOC), the display unit 180 for displaying an image, the audio output unit 185 for outputting audio, and the like.

Specifically, the power supply unit 190 may include a converter that converts AC power to DC power and a DC/DC converter that converts a level of the DC power.

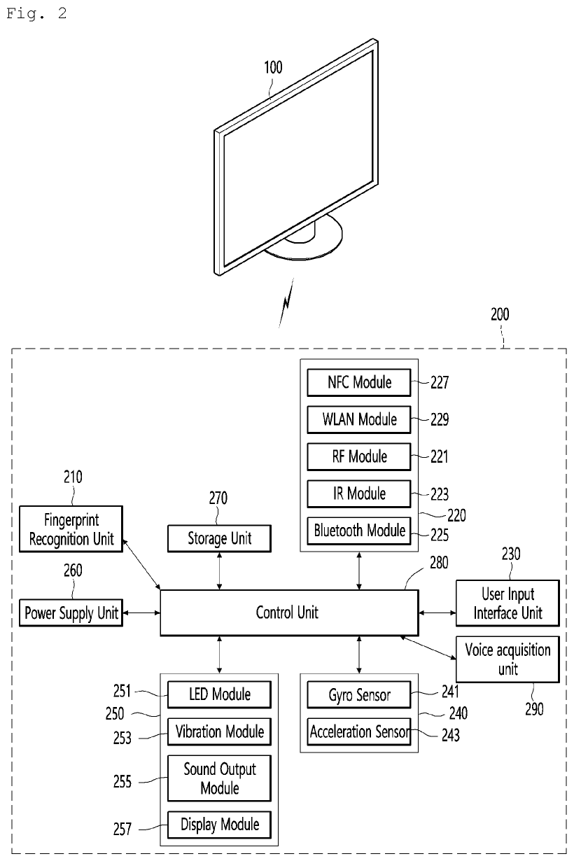

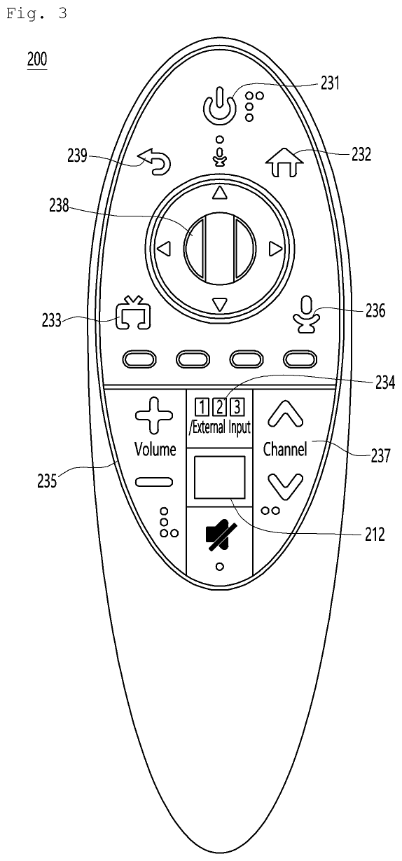

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication unit 220, a user input interface unit 230, a sensor unit 240, an output unit 250, a power supply unit 260, a storage unit 270, a control unit 280, and a voice acquisition unit 290.

Referring to FIG. 2, the wireless communication unit 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication unit 220.

Moreover, the remote control device 200 may receive signals transmitted from the display device 100 through the RF module 221 and if necessary, may transmit a command for power on/off, channel change, and volume change to the display device 100 through the IR module 223.

The user input interface unit 230 may be configured with a keypad, a button, a touch pad, or a touch screen. A user may operate the user input interface unit 230 to input a command relating to the display device 100 to the remote control device 200. If the user input interface unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be a button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The volume control button 235 may be a button for controlling a volume output from the display device 100. The voice recognition button 236 may be a button for receiving user's voice and recognizing the received voice. The channel change button 237 may be a button for receiving broadcast signals of a specific broadcast channel. The OK button 238 may be a button for selecting a specific function, and the back button 239 may be a button for returning to a previous screen.

FIG. 2 is described again.

If the user input interface unit 230 includes a touch screen, a user may touch a soft key of the touch screen to input a command relating to the display device 100 to the remote control device 200. In addition, the user input interface unit 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display unit 180 of the display device 100.

The output unit 250 may output image or voice signals in response to the operation of the user input interface unit 230, or may output image or voice signals corresponding to signals transmitted from the display device 100. A user may recognize whether the user input interface unit 230 is operated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input interface unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste may be reduced. The power supply unit 260 may resume the supply of power if a predetermined key provided at the remote control device 200 is operated.

The storage unit 270 may store various kinds of programs and application data required to control or operate the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input interface unit 230 or a signal corresponding to the movement of the remote control device 200 sensed by the sensor unit 240 to the display device 100 through the wireless communication unit 220.

In addition, the voice acquisition unit 290 of the remote control device 200 may acquire voice.

The voice acquisition unit 290 may include at least one microphone and acquire voice through the microphone.

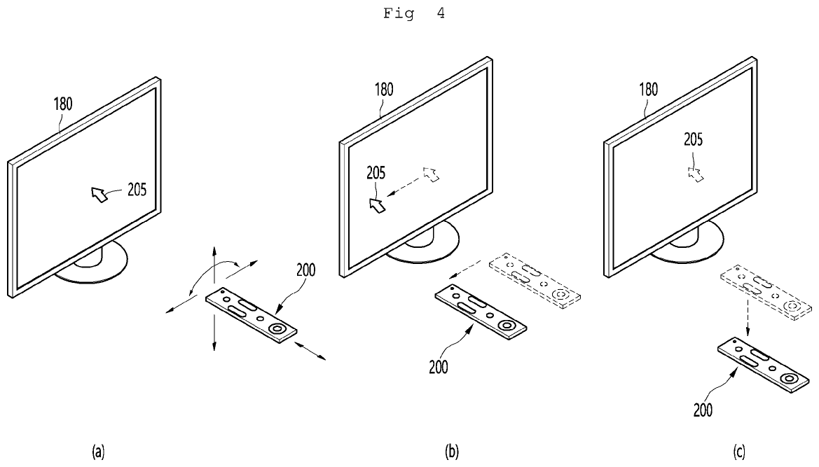

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selected region in the display unit 180 corresponding to the pointer 205 may be zoomed in and displayed in an enlarged size.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. That is, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

The control unit 170 may also be referred to as a processor 170. In addition, the storage unit 140 may be referred to as a memory 140. In addition, the wireless communication unit 173 may be referred to as a communication interface 173.

The display unit 180 may include a timing controller (T-CON) 181 used in a conventional display technology, and may include a display panel 182. When the display panel 182 is an organic light-emitting diode (OLED), high potential power (EVDD) may be supplied, and when the display panel 182 is a liquid crystal display (LCD), a light source power voltage (VLED) may be supplied to a backlight unit (BLU).

On the other hand, the display device 100 may further include a motor 400 that provides a power source for movement of the display unit 180. The movement of the display unit 180 may include a rotating, folding, rolling, or moving movement. That is, the display unit 180 may be rotated so as to be rotated left and right or tilted back and forth in a landscape mode and a portrait mode. The display unit 180 may be foldable. The display unit 180 may be rollable. In addition, the display unit 180 may be movable vertically or horizontally.

The rotating, folding, rolling, or moving movement of the display unit 180 may be implemented by using a conventional display technology utilizing the power source of the motor 400.

On the other hand, when the motor 400 supplies the power source for the movement of the display unit 180, the power supply unit 190 must be able to supply power to the motor 400.

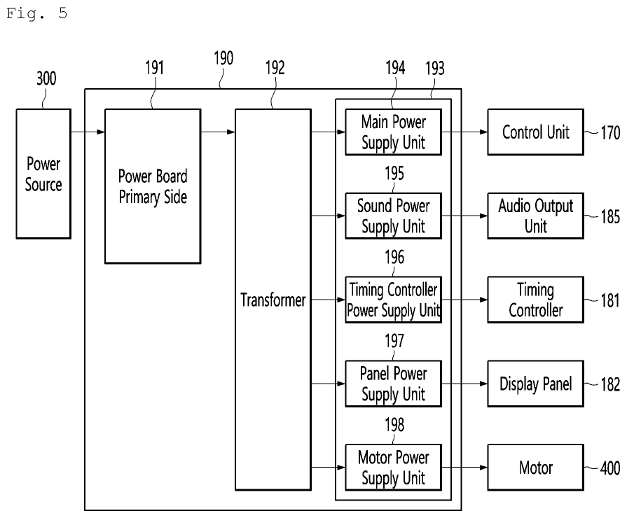

FIG. 5 is a block diagram illustrating the power supply unit according to an embodiment of the related art.

The power supply unit 190 may receive power from an external power source 300. The external power source 300 may supply AC power and may have a voltage range of 100 V to 240 V.

On the other hand, the power supply unit 190 may include a power board primary side 191. The power board primary side 191 may receive power from the external power source 300. The power board primary side 191 may receive a power capacity corresponding to a required power capacity of a power board secondary side 193. For example, when the required power capacity of the power board secondary side 193 is 282 W, the power capacity of the power board primary side 191 may also be designed to be 282 W.

On the other hand, the power supply unit 190 may include a transformer 192. The transformer 192 may distribute and output the power of the power board primary side 191 to the power board secondary side 193.

On the other hand, the power supply unit 190 may include a main power supply unit 194 that supplies power required for the control unit 170. For example, the main power supply unit 194 may supply power to the main board of the control unit 170. The main power supply unit 194 may have a power capacity of 36 W (12 V, 3 A).

In addition, the power supply unit 190 may include a sound power supply unit 195 that supplies power required for the audio output unit 185. For example, the sound power supply unit 195 may supply power to a speaker of the audio output unit 185. The sound power supply unit 195 may have a power capacity of 40 W (20 V, 2 A).

In addition, the power supply unit 190 may include a timing controller power supply unit 196 that supplies power required for the timing controller (T-CON) 181. For example, the timing controller power supply unit 196 may supply power to the timing controller 181 of the display unit 180. The timing controller power supply unit 196 may have a power capacity of 24 W (12 V, 2 A).

In addition, the power supply unit 190 may include a panel power supply unit 197 that supplies power required for the display panel 182. For example, the panel power supply unit 195 may supply power to the display panel 182. The panel power supply unit 195 may have a power capacity of 110 W (22 V, 2 A).

On the other hand, the power supply unit 190 may include a motor power supply unit 198 that supplies power required for the motor 400. For example, the motor power supply unit 198 may supply power to the motor 400. The motor power supply unit 198 may have a power capacity of 72 W (24 V, 3 A).

In this case, the required power capacity of the power board secondary side 193 may be a total of 282 W, and the power capacity of the power board primary side 191 may also be designed to be 282 W.

However, when a separate motor power supply unit 198 is designed to supply power to the motor 400, it is necessary to increase the design capacity of the power board and add parts. In addition, it is necessary to additionally configure a wafer and a cable dedicated to the motor. Due to this, there is a problem in that the cost increases. Therefore, there is a need for a method of supplying power to the motor 400 without adding a separate motor power supply unit 198.

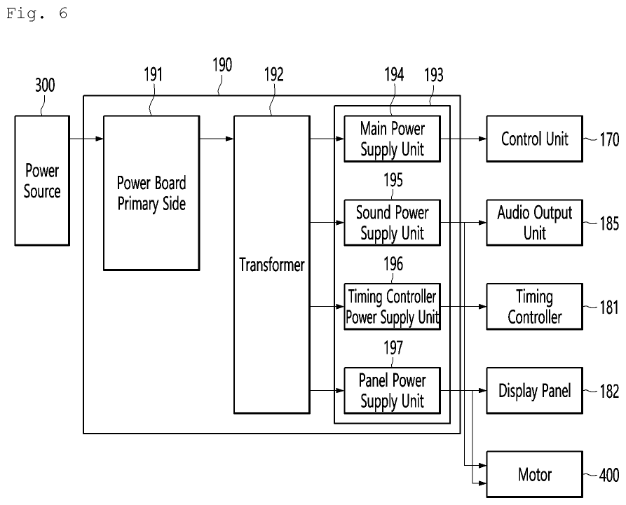

FIG. 6 is a block diagram illustrating the power supply unit according to an embodiment of the present disclosure.

Referring to FIG. 6, unlike the power supply unit of FIG. 5, the power supply unit 190 may not include the motor power supply unit 198. Instead, the power supplied to the motor 400 may be supplied from the sound power supply unit 195 or the panel power supply unit 197.

In this case, the required power capacity of the power board secondary side 193 may be a total of 210 W, and the power capacity of the power board primary side 191 may also be designed to be 210 W.

Therefore, the power board design capacity can be reduced by the power capacity required to drive the motor 400, the PCB size of the power board can be reduced, and the input of parts such as wafers and cables dedicated to the motor can also be reduced. Therefore, the costs can be reduced.

However, since the motor 400 uses the power supplied to the audio output unit 185 or the display panel 182, it is necessary to perform an operation of controlling the power supplied to the audio output unit 185 or the display panel 182 when the driving of the motor 400 is required.

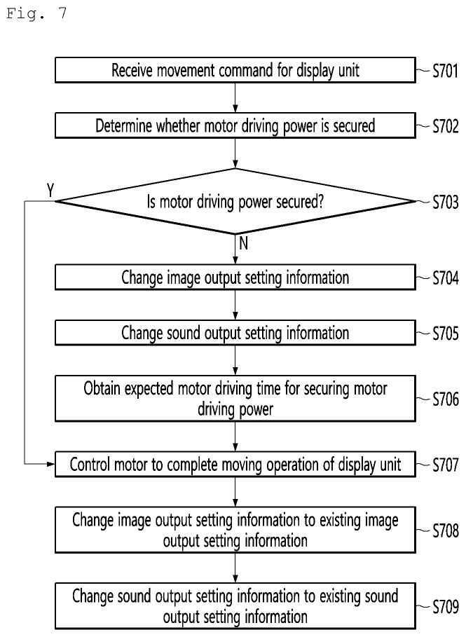

FIG. 7 is a flowchart for describing a motor control method according to an embodiment of the present disclosure.

The processor 170 may receive a movement command for the display unit 180 (S701). For example, the processor 170 may receive a movement command for the display unit 180 through the user input interface unit 150.

On the other hand, the movement command for the display unit 180 may include at least one of commands for rotating, folding, rolling, and moving the display unit 180.

The processor 170 may determine whether motor driving power required for the motor 400 that provides the power source for the movement of the display unit 180 is secured (S702).

The processor 170 may determine whether the motor driving power required for the motor 400 is secured in response to the received movement command.

In addition, the processor 170 may determine whether the motor driving power required from the start of the moving operation of the display unit 180 corresponding to the movement command to the completion of the moving operation of the display unit 180 is secured.

For example, when the movement command for the display unit 180 is a rotating command, the processor 170 may determine whether the motor driving power required from the start of the rotation of the display unit 180 to the completion of the rotation of the display unit 180 is secured.

In addition, the processor 170 may obtain current total power consumption of the display device 100, based on the power usage rates of the control unit 170, the audio output unit 185, the timing controller 181, the display panel 182, and the motor 400.

In addition, the processor 170 may determine whether the motor driving power is secured, based on whether the sum of the current total power consumption and the required motor driving power exceeds a limit power consumption. The limit power consumption may refer to a total power consumption that can ensure stability, based on the power design capacity of the power board.

On the other hand, when the processor 170 determines that the motor driving power required to complete the movement of the display unit 180 is secured, the processor 171 may control the motor 400 to perform and complete the moving operation of the display unit 180 (S703, S707).

The processor 170 may control the motor 400, which receives power from the sound power supply unit 195 or the panel power supply unit 197, to complete the moving operation of the display unit 180.

On the other hand, when the motor driving power required to complete the movement of the display unit 180 is not secured, the processor 170 may secure the motor driving power by changing image output setting information of the image source (S704).

The processor 170 may change the image output setting information to reduce the power usage rate of the display panel 182 of the display unit 180, thereby securing the motor driving power.

For example, the processor 170 may change the image output setting information by setting the image brightness setting of the image source to be darker than the existing image brightness setting and may secure the motor driving power required for the motor 400.

The processor 170 may reduce the power usage rate of the panel by setting the image brightness setting to be darker than the existing image brightness setting, thereby reducing the power consumed by the panel. In this case, the processor 170 may secure the driving power required for the motor 400.

In addition, for example, the processor 170 may change the image output setting information by setting the image size setting of the image source to be smaller than the existing image size setting and may secure the motor driving power required for the motor 400.

The processor 170 may reduce the power usage rate of the panel by setting the image size setting to be smaller than the existing image size setting, thereby reducing the power consumed by the panel. In this case, the processor 170 may secure the driving power required for the motor 400.

The processor 170 may secure the motor driving power by changing the image output setting information of the image source, and may control the motor 400 to complete the moving operation of the display unit 180 (S707).

The processor 170 may control the motor 400, which receives power from the panel power supply unit 197, to perform and complete the moving operation of the display unit 180.

The processor 170 may control the panel power supply unit 197 to supply power to the motor 400.

In addition, the processor 170 may change the image output setting information of the image source to the existing image output setting information (S708).

For example, the processor 170 may change the image output setting information to the existing image output setting information by changing the image brightness setting to the existing image brightness setting before change. Therefore, the processor 170 may darkly output the image during the rotation of the display to secure the motor driving power, and may brightly output the image again when the rotation is completed.

For example, the processor 170 may change the image output setting information to the existing image output setting information by changing the image size setting to the existing image size setting before change. Therefore, the processor 170 may output a small image during the rotation of the display to secure the motor driving power, and may output a large image again when the rotation is completed.

On the other hand, when the motor driving power required to complete the movement of the display unit 180 is not secured, the processor 170 may secure the motor driving power by changing image output setting information of the image source (S705).

The processor 170 may change the sound output setting information to reduce the power usage rate of the audio output unit 185, thereby securing the motor driving power.

For example, the processor 170 may set the sound setting of the image source to be lower than the existing sound setting to reduce the power usage rate of the audio output unit 185, thereby reducing power consumed by the speaker. In this case, the processor 170 may secure the driving power required for the motor 400.

In addition, for example, the processor 170 may set the sound setting of the image source to mute to minimize the power usage rate of the audio output unit 185. In this case, the processor 170 may maximally secure the driving power required for the motor 400.

On the other hand, when the motor driving power required to complete the movement of the display unit 180 is not secured, the processor 170 may secure the motor driving power by reducing the power usage rate of the main power supply unit 194. For example, the processor 170 may lower the speed of a CPU or the like of the main board to reduce the power consumed by the main board of the control unit 170 so as to lower the power load and secure the motor driving power.

On the other hand, when the motor driving power required to complete the movement of the display unit 180 is not secured, the processor 170 may secure motor driving power by reducing the power usage rate of the timing controller power supply unit 196. For example, the processor 170 may reduce the power load by lowering the data transmission rate of the timing controller, thereby securing the motor driving power.

The processor 170 may secure the motor driving power by changing the sound output setting information of the image source, and may control the motor 400 to complete the moving operation of the display unit 180 (S707).

The processor 170 may control the motor 400, which receives power from the sound power supply unit 195, to complete the moving operation of the display unit 180.

The processor 170 may control the sound power supply unit 195 to supply power to the motor 400.

In addition, the processor 170 may change the sound output setting information of the image source to the existing sound output setting information (S709).

For example, the processor 170 may change the sound output setting information to the existing sound output setting information by changing the image sound setting to the existing image sound setting. Therefore, the processor 170 may output a low sound during the rotation of the display to secure the motor driving power, and may output a high sound again when the rotation is completed.

On the other hand, in general, maximum motor driving power is required when the motor 400 starts driving, and low motor driving power is required while the motor 400 is driving. Therefore, the processor 170 may mute sound or output low sound when the display unit 180 starts moving, so as to secure the maximum power when the motor 400 starts driving, and may set the sound to be gradually increased during the movement of the display unit 180. Therefore, when the moving operation of the display unit 180 is completed, the image sound setting may be controlled so that the sound output setting information is naturally changed to the existing sound output setting information.

On the other hand, when the motor driving power required to complete the movement of the display unit 180 is not secured, the processor 170 may obtain an expected motor driving time for securing the motor driving power (S706).

The processor 170 may obtain image display power consumption of the display panel 182 of the display unit 180 in a predetermined image reproduction section based on the image source displayed on the display unit 180. The processor 170 may determine whether the motor driving power is secured, based on the obtained image display power consumption and limit power consumption. In addition, when the processor 170 can secure the motor driving power by reducing the image display power consumption in the predetermined image reproduction section, the processor 170 may obtain the expected motor driving time from when the reproduction of the corresponding image reproduction section starts to the time when the reproduction ends.

In addition, when the motor driving power is not secured in a first predetermined image reproduction section, the processor 170 may determine whether motor driving power is secured in a second image reproduction section shifted by a predetermined time.

The processor 170 may obtain image display power consumption of the display panel 182 based on the image source displayed on the display unit 180. In addition, the processor 170 may determine whether the motor driving power is secured based on the image display power consumption.

In addition, the processor 170 may obtain image display power consumption of the display panel 182 based on brightness information of the image source displayed on the display unit 180. For example, when the display panel 182 is an organic light emitting diode panel, the image display power consumption may be lower as the ratio of the screen displayed in black on the image source is higher.

In addition, the processor 170 may obtain image display power consumption expected in the display panel 182, based on the image source from the expected driving start time when the driving of the motor 400 is expected to start to the expected driving end time when the driving of the motor 400 is ended.

For example, when the movement command for the display unit 180 is input at 15:32:01, the expected driving start time when the driving of the motor 400 is expected to start is 15:32:02, and the expected driving end time when the driving of the motor 400 is ended is 15:32:12, image display power consumption of the display panel 182 may be obtained based on the image source corresponding to the image reproduction section from 15:32:02, which is the expected driving start time, to 15:32:12, which is the expected driving end time. In this case, the processor 170 may obtain image display power consumption for the expected driving time of the motor. The processor 170 may determine whether the driving power of the motor is secured, based on the image display power consumption for the expected driving time of the motor.

The processor 170 may obtain the expected motor driving time for securing the motor driving power, and may control the motor 400 for the expected motor driving time to complete the moving operation of the display unit 180 (S707).

The processor 170 may control the motor 400, which receives power from the panel power supply unit 197 for the expected driving time of the motor, to complete the moving operation of the display unit 180.

The processor 170 may control the panel power supply unit 197 to supply power to the motor 400 for the expected driving time of the motor.

For example, the moving operation of the display unit 180 may be completed by controlling the motor 400 from 15:32:02, which is the expected driving start time of the motor, to 15:32:12, which is the expected driving end time of the motor.

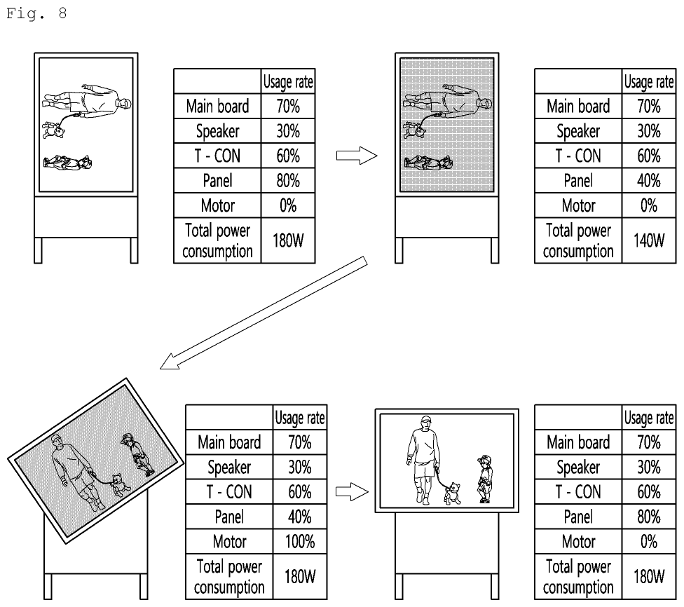

FIG. 8 is a view for describing a motor control method for securing motor driving power by changing image output setting information of an image source according to an embodiment of the present disclosure.

Referring to FIG. 8, the power usage rates of the main board, the speaker, the timing controller (T-CON), the panel, and the motor may be 70%, 30%, 60%, 80%, and 0%, respectively, and the total power consumption may be 180 W. In this case, the main board may receive power through the main power supply unit 194, the speaker may receive power through the sound power supply unit 195, the timing controller (T-CON) may receive power through the timing controller power supply unit 196, the panel may receive power through the panel power supply unit 197, and the motor may receive power through the panel power supply unit 197 or the sound power supply unit 195.

On the other hand, the processor 170 may receive the movement command for the display unit 180 through the user input interface unit 150.

In addition, the processor 170 may determine whether the motor driving power required for the motor 400 that provides the power source for the movement of the display unit 180 is secured.

The processor 170 may determine whether the motor driving power required for the motor 400 is secured by comparing the current total power consumption with the limit power consumption at which the maximum power can be used. For example, when the required motor driving power is 40 W and the limit power consumption is 180 W, the processor 170 may determine that the driving power required for the motor 400 is not secured.

The processor 170 may secure the motor driving power by changing the image output setting information to reduce the power usage rate of the panel.

For example, the processor 170 may set the image brightness setting to be dark to reduce the power usage rate of the panel from 80% to 40%, thereby reducing the power consumption of the panel. In this case, the processor 170 may secure the driving power of 40 W required for the motor 400.

In addition, when the motor driving power is secured, the processor 170 may control the motor 400 to complete the moving operation of the display unit 180.

For example, the processor 170 may supply power of 40 W to the motor 400 through the panel power supply unit 197 and operate the motor at the power usage rate of 100% to thereby complete the moving operation of the display unit 180.

In addition, the processor 170 may change the image output setting information to the existing image output setting information after completing the moving operation of the display unit 180.

For example, the processor 170 may brightly change the image brightness setting to the existing brightness setting to increase the power usage rate of the panel from 40% to 80%, thereby increasing the power consumption of the panel.

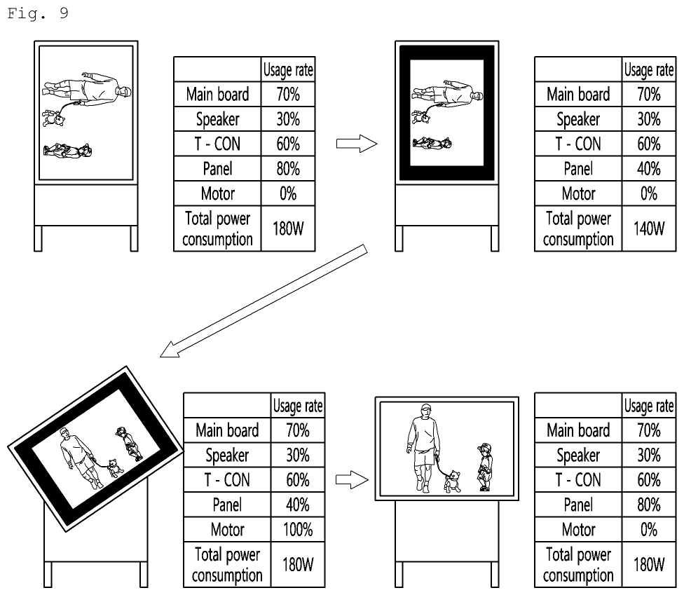

FIG. 9 is a view for describing a motor control method for securing motor driving power by changing image output setting information of an image source according to an embodiment of the present disclosure.

Referring to FIG. 9, the power usage rates of the main board, the speaker, the timing controller (T-CON), the panel, and the motor may be 70%, 30%, 60%, 80%, and 0%, respectively, and the total power consumption may be 180 W. In this case, the main board may receive power through the main power supply unit 194, the speaker may receive power through the sound power supply unit 195, the timing controller (T-CON) may receive power through the timing controller power supply unit 196, the panel may receive power through the panel power supply unit 197, and the motor may receive power through the panel power supply unit 197 or the sound power supply unit 195.

On the other hand, the processor 170 may receive the movement command for the display unit 180 through the user input interface unit 150.

In addition, the processor 170 may determine whether the motor driving power required for the motor 400 that provides the power source for the movement of the display unit 180 is secured.

The processor 170 may determine whether the motor driving power required for the motor 400 is secured by comparing the current total power consumption with the limit power consumption at which the maximum power can be used. For example, when the required motor driving power is 40 W and the limit power consumption is 180 W, the processor 170 may determine that the driving power required for the motor 400 is not secured.

The processor 170 may secure the motor driving power by changing the image output setting information to reduce the power usage rate of the panel.

For example, the processor 170 may set the image size setting to be small to reduce the power usage rate of the panel from 80% to 50%, thereby reducing the power consumption of the panel. In this case, the processor 170 may secure the driving power of 40 W required for the motor 400.

In addition, when the motor driving power is secured, the processor 170 may control the motor 400 to complete the moving operation of the display unit 180.

For example, the processor 170 may supply power of 40 W to the motor 400 through the panel power supply unit 197 and operate the motor at the power usage rate of 100% to thereby complete the moving operation of the display unit 180.

In addition, the processor 170 may change the image output setting information to the existing image output setting information after completing the moving operation of the display unit 180.

For example, the processor 170 may greatly change the image size setting to the existing size setting to increase the power usage rate of the panel from 40% to 80%, thereby increasing the power consumption of the panel.

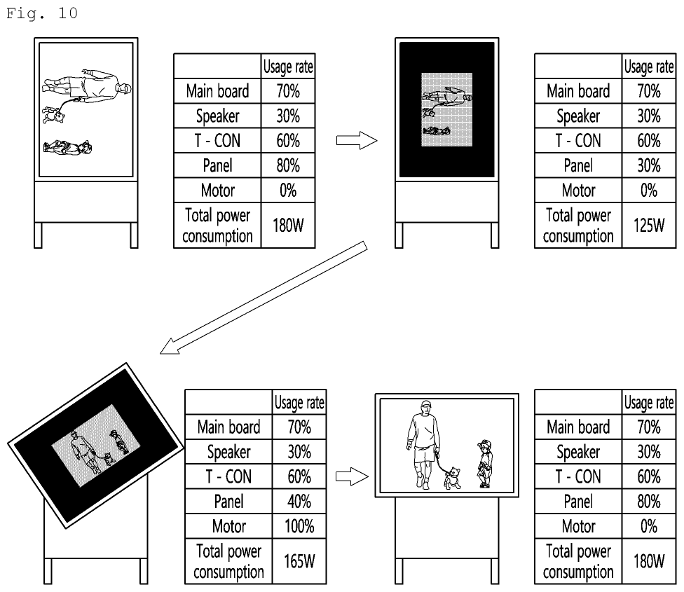

FIG. 10 is a view for describing a motor control method for securing motor driving power by changing image output setting information of an image source according to an embodiment of the present disclosure.

Referring to FIG. 10, the power usage rates of the main board, the speaker, the timing controller (T-CON), the panel, and the motor may be 70%, 30%, 60%, 80%, and 0%, respectively, and the total power consumption may be 180 W. In this case, the main board may receive power through the main power supply unit 194, the speaker may receive power through the sound power supply unit 195, the timing controller (T-CON) may receive power through the timing controller power supply unit 196, the panel may receive power through the panel power supply unit 197, and the motor may receive power through the panel power supply unit 197 or the sound power supply unit 195.

On the other hand, the processor 170 may receive the movement command for the display unit 180 through the user input interface unit 150.

On the other hand, the processor 170 may lower the power usage rate of the panel by changing the image output setting information without determining whether the motor driving power is secured.

For example, when the processor 170 receives the movement command, the processor 170 may change the image size setting to be reduced to a preset image size and change the image brightness setting to be reduced to a preset brightness. In this case, it is possible to secure the power of 65 W, which is more than the required motor driving power of 40 W.

In addition, the processor 170 may control the motor 400 to complete the moving operation of the display unit 180.

For example, the processor 170 may supply power of 40 W to the motor 400 through the panel power supply unit 197 and operate the motor at the power usage rate of 100% to thereby complete the moving operation of the display unit 180. In this case, the power of 165 W, which is less than the limit power consumption of 180 W, may be consumed.

In addition, the processor 170 may change the image output setting information to the existing image output setting information after completing the moving operation of the display unit 180.

For example, the processor 170 may greatly set the image size setting to the existing image size setting and brightly set the image brightness setting to the existing image brightness setting to increase the power usage rate of the panel from 30% to 80%, thereby increasing the power consumption of the panel.

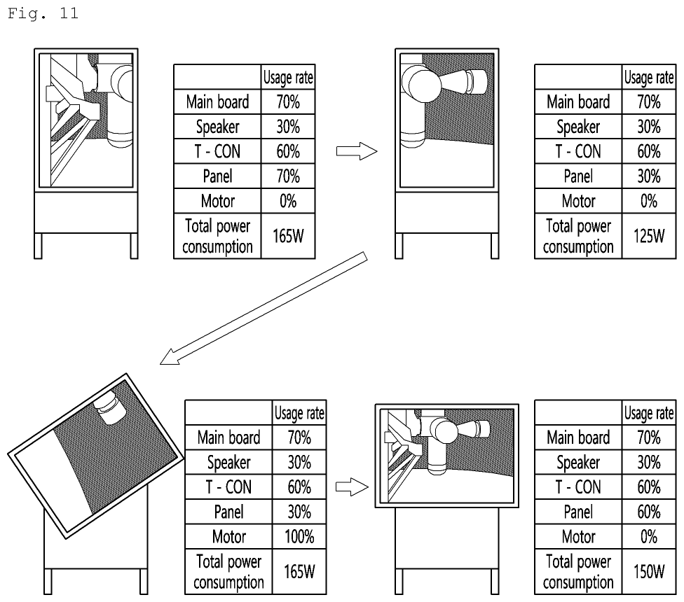

FIG. 11 is a diagram for describing a motor control method for securing motor driving power by waiting until an image section in which driving power can be secured according to an embodiment of the present disclosure.

Referring to FIG. 11, the power usage rates of the main board, the speaker, the timing controller (T-CON), the panel, and the motor may be 70%, 30%, 60%, 70%, and 0%, respectively, and the total power consumption may be 165 W. In this case, the main board may receive power through the main power supply unit 194, the speaker may receive power through the sound power supply unit 195, the timing controller (T-CON) may receive power through the timing controller power supply unit 196, the panel may receive power through the panel power supply unit 197, and the motor may receive power through the panel power supply unit 197 or the sound power supply unit 195.

On the other hand, the processor 170 may receive the movement command for the display unit 180 through the user input interface unit 150.

On the other hand, the processor 170 may determine whether the motor driving power is secured.

For example, the processor 170 may obtain image display power consumption expected in the display panel 182, based on the image source from the expected driving start time when the driving of the motor 400 is expected to start to the expected driving end time when the driving of the motor 400 is ended. In this case, the processor 170 may obtain image display power consumption for the expected driving time of the motor 40. In addition, the processor 170 may determine whether the driving power of the motor is secured, based on the image display power consumption, the total power consumption, and the required motor driving power for the expected driving time of the motor.

For example, when the movement command for the display unit 180 is input at 15:32:01, the expected driving start time when the driving of the motor 400 is expected to start is 15:32:02, and the expected driving end time when the driving of the motor 400 is ended is 15:32:12, expected image display power consumption expected to be consumed by the display panel 182 may be obtained based on the image source from 15:32:02, which is the expected driving start time, to 15:32:12, which is the expected driving end time. In this case, the processor 170 may obtain image display power consumption for the expected driving time of the motor.

Referring to FIG. 11, as a dark area increases in the image source from the expected driving start time to the expected driving end time, the power usage rate of the panel may be lowered from 70% to 30%. The processor 170 may determine that the expected total power consumption is 165 W, which is less than the limit power consumption, even when the motor is operated for the expected driving time. The processor 170 may determine that the motor driving power is secured, and may supply power to the motor 400 through the panel power supply unit 197 at the expected driving start time to complete the moving operation of the display unit 180.

On the other hand, when the processor 170 determines that the motor driving power is not secured for the expected driving time of the motor, the processor 170 may shift the expected driving time by a predetermined time. The processor 170 may obtain image display power consumption for the shifted expected driving time.

For example, when the shifted expected driving start time is 15:33:02 and the shifted expected driving end time is 15:33:12, expected image display power consumption expected to be consumed by the display panel 182 may be obtained based on the image source from 15:33:02, which is the expected driving start time, to 15:33:12, which is the expected driving end time.

The processor 170 may determine whether the motor driving power is secured, based on the expected image display power consumption. When the motor driving power is secured, the processor 170 may complete the moving operation of the display unit 180 by supplying power to the motor at the shifted expected driving start time.

The above description is merely illustrative of the technical spirit of the present disclosure, and various modifications and changes can be made by those of ordinary skill in the art, without departing from the scope of the present disclosure.

Therefore, the embodiments disclosed in the present disclosure are not intended to limit the technical spirit of the present disclosure, but are intended to explain the technical spirit of the present disclosure. The scope of the technical spirit of the present disclosure is not limited by these embodiments.

The scope of the present disclosure should be interpreted by the appended claims, and all technical ideas within the scope equivalent thereto should be construed as falling within the scope of the present disclosure.

What is claimed is:

1. A display device comprising:
a display unit configured to output an image source;
a motor configured to provide a power source for movement of the display unit;
a panel power supply unit configured to output power supplied from an external power source to the display unit or the motor; and
a processor configured to:
receive a movement command for the display unit;
determine whether motor driving power required for the motor is secured in response to the movement command; and
when it is determined that the motor driving power is secured, control the motor receiving power from the panel power supply unit to perform a moving operation of the display unit.

2. The display device of claim 1, wherein, when it is determined that the motor driving power is not secured, the processor is configured to change image output setting information of the image source to secure the motor driving power required for the motor.

3. The display device of claim 2, wherein the processor is configured to change the image output setting information by setting an image brightness setting of the image source to be darker than an existing image brightness setting and secure the motor driving power required for the motor.

4. The display device of claim 2, wherein the processor is configured to change the image output setting information by setting an image size setting of the image source to be smaller than an existing image size setting and secure the motor driving power required for the motor.

5. The display device of claim 2, wherein the processor is configured to perform a moving operation of the display unit and change the image output setting information of the image source to existing image output setting information.

6. The display device of claim 1, further comprising:
an audio output unit configured to output audio of the image source; and
a sound power supply unit configured to output the power supplied from the external power source to the audio output unit or the motor,
wherein, when it is determined that the motor driving power is secured, the processor is configured to control the motor receiving the power from the sound power supply unit to perform the moving operation of the display unit.

7. The display device of claim 6, wherein, when it is determined that the motor driving power is not secured, the processor is configured to change sound output setting information of the image source to secure the motor driving power required for the motor.

8. The display device of claim 7, wherein the processor is configured to perform the moving operation of the display unit and change the sound output setting information of the image source to existing sound output setting information.

9. The display device of claim 1, wherein the processor is configured to obtain an expected motor driving time for securing the motor driving power required for the motor, and perform the moving operation of the display unit by controlling the motor receiving the power from the panel power supply unit for the obtained expected motor driving time.

10. The display device of claim 9, wherein the processor is configured to:
obtain image display power consumption of the display unit in a first image reproduction section based on the image source;
determine whether the motor driving power is secured, based on the obtained image display power consumption and limit power consumption; and
when it is possible to secure the motor driving power in the first image reproduction section, obtain an expected motor driving time from a reproduction start time to a reproduction end time of the first image reproduction section.

11. The display device of claim 10, wherein, when it is impossible to secure the motor driving power in the first image reproduction section, the processor is configured to shift the first image reproduction section by a predetermined time and determine whether it is possible to secure the motor driving power in a second image reproduction section.

12. The display device of claim 1, wherein the movement command includes at least one of commands for rotating, folding, rolling, and moving the display unit.

13. The display device of claim 1, wherein the processor is configured to determine whether the motor driving power required for the motor from start of the moving operation of the display unit corresponding to the movement command to completion of the moving operation of the display unit is secured.

14. The display device of claim 1, wherein the processor is configured to determine whether the motor driving power required for the motor is secured, based on limit power consumption and total power consumption of the display device.
